(19) United States
(12) Patent Application Publication
(10) Pub. No.: US 2020/0116577 A1
(43) Pub. Date: Apr. 16, 2020

(54) TACTILE SENSOR

(71) Applicant: JTEKT CORPORATION, Osaka (JP)

(72) Inventor: Takeshi KAWABAYASHI, Kashiba-shi (JP)

(73) Assignee: JTEKT CORPORATION, Osaka (JP)

(21) Appl. No.: 16/572,703

(22) Filed: Sep. 17, 2019

(30) Foreign Application Priority Data
Oct. 11, 2018 (JP) 2018-192715

(51) Int. Cl. G01L 1/12

(52) U.S. Cl. CPC G01L 1/127

(57) ABSTRACT

A tactile sensor includes: an element that changes an inductance of the element with deformation of the element and that includes a coil; a first deformation layer that has the element embedded in the first deformation layer and is elastically deformable together with the element; and an elastically deformable surface layer that is placed on the first deformation layer and contains a magnetic material.

### INCORPORATION BY REFERENCE

The disclosure of Japanese Patent Application No. 2018-192715 filed on Oct. 11, 2018 including the specification, drawings and abstract is incorporated herein by reference in its entirety.

### BACKGROUND

### 1. Technical Field

The disclosure relates to tactile sensors.

### 2. Description of Related Art

Recently, robots with human flexibility and a sense of touch have been increasingly developed. Such robots use a tactile sensor in order to achieve a human tactile function. Such a tactile sensor uses a soft material such as elastomer or rubber for human flexibility.

For example, Japanese Unexamined Patent Application Publication No. 2018-17536 (JP 2018-17536 A) proposes such a deformation measurement device 2 as shown in FIG. 5 as a tactile sensor. The deformation measurement device 2 includes a first layer 4, a second layer 6, a member 8, and a sensor 10. The first layer 4 is a deformable layer with a magnetic material dispersed therein so as to produce a magnetic field gradient. The second layer 6 is a deformable layer placed approximately parallel to the first layer 4. The member 8 is a member for generating a magnetic field. The sensor 10 is a sensor for measuring magnetic flux density.

In the deformation measurement device 2, as shown in FIG. 5, the magnetic flux density of the magnetic field generated by the member 8 changes when the first layer 4 is pressed with a finger. The magnetic flux density is measured by the sensor 10. The amount of deformation of the first layer 4 is calculated by a control unit 12 based on the measurement result of the magnetic flux density.

In the deformation measurement device 2 shown in FIG. 5, the member 8 for generating a magnetic field is placed on a substrate 14 so as to contact the back surface of the second layer 6. In the deformation measurement device 2, the first layer 4 and the second layer 6 form a flexible layer, and the member 8 for generating a magnetic field and a part of the substrate 14 form a sensing circuit layer.

In the deformation measurement device 2, the distance between the first layer 4 and the sensing circuit layer changes with deformation of the flexible layer. Such a change in distance is detected based on a change in magnetic flux density of the magnetic field generated by the member 8 embedded in the sensing circuit layer.

### SUMMARY

When the deformation measurement device 2 shown in FIG. 5 has a thick flexible layer in order to have sufficient flexibility, it has reduced sensitivity to deformation of the flexible layer. On the other hand, if the deformation measurement device 2 has a thin flexible layer, it has improved sensitivity to deformation of the flexible layer but has reduced flexibility. A tactile sensor is therefore desired which has high sensitivity to deformation while having sufficient flexibility.

The disclosure provides a tactile sensor having high sensitivity to deformation while having sufficient flexibility.

A tactile sensor includes: an element that changes an inductance of the element with deformation of the element and that includes a coil; a first deformation layer that has the element embedded in the first deformation layer and is elastically deformable together with the element; and an elastically deformable surface layer that is placed on the first deformation layer and contains a magnetic material. In this tactile sensor, when the surface layer is pressed and elastically deformed, the first deformation layer is also elastically deformed. Since the element is embedded in the first deformation layer, the element is also deformed when the surface layer is deformed. In this tactile sensor, the inductance of the element changes with deformation of the element itself, and the surface layer containing the magnetic material improves the rate of change in inductance. This tactile sensor thus has high sensitivity to deformation. Since deformation of the element itself is reflected on a change in inductance, the elastically deformable surface layer or the elastically deformable first deformation layer of the tactile sensor can have a sufficient thickness. In other words, the surface layer or the first deformation layer of the tactile sensor can have a sufficient thickness within such a range that does not inhibit deformation of the element itself. This tactile sensor thus has high sensitivity to deformation while having sufficient flexibility.

In the above tactile sensor, the magnetic material may have a flat shape. This configuration facilitates orientation of the magnetic material dispersed in the surface layer of the tactile sensor. The orientation of the magnetic material improves sensitivity to deformation. The tactile sensor thus has higher sensitivity to deformation while having more sufficient flexibility.

In the above tactile sensor, the element may include a core material comprised of an amorphous metal fiber, and the core material may be placed along the coil. Since amorphous metal fibers do not have crystal magnetic anisotropy, this configuration further increases a change in inductance associated with deformation of the element. This tactile sensor thus has further improved sensitivity to deformation. This tactile sensor therefore has higher sensitivity to deformation while having more sufficient flexibility.

The above tactile sensor may further include an elastically deformable second deformation layer, the first deformation layer may be stacked on the second deformation layer, and the second deformation layer may be more flexible than the first deformation layer. With this configuration, since the first deformation layer is sufficiently deformable, a force pressing the surface layer effectively acts on the element. Since deformation caused by the pressing force is sufficiently reflected on deformation of the element, this tactile sensor has further improved sensitivity to deformation. This tactile sensor thus has higher sensitivity to deformation while having more sufficient flexibility.

As can be seen from the above description, the disclosure provides a tactile sensor having high sensitivity to deformation while having sufficient flexibility.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic diagram showing an example of a tactile sensor according to an embodiment of the disclosure;

FIG. 2 is a diagram illustrating the tactile sensor in use;

FIG. 3 is a graph showing the relationship between the amount of depression and the inductance which is obtained by the tactile sensor;

FIG. 4A shows an electron micrograph showing the oriented state of a magnetic material dispersed in a surface layer of the tactile sensor of FIG. 1;

FIG. 4B shows a replica of the electron micrograph of FIG. 4A; and

FIG. 5 is a schematic diagram of a deformation measurement device as a conventional tactile sensor.

### DETAILED DESCRIPTION OF EMBODIMENTS

The disclosure will be described in detail based on a preferred embodiment with reference to the accompanying drawings.

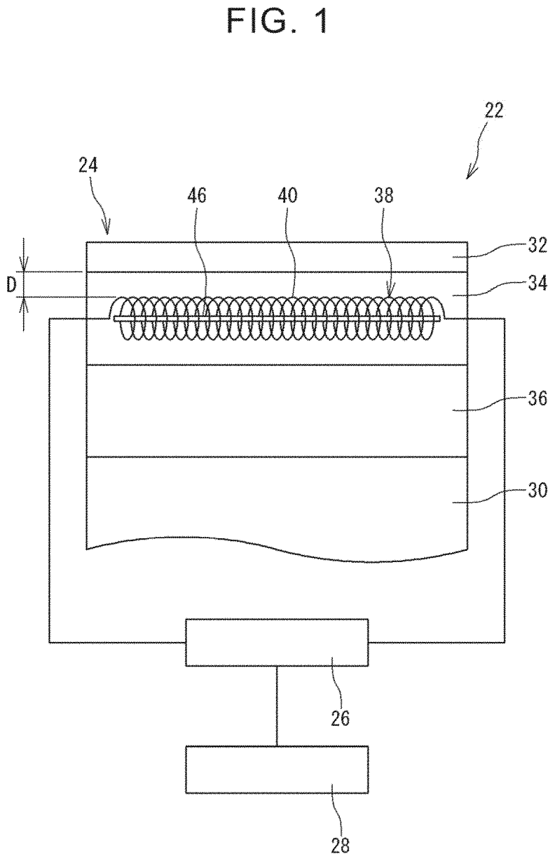

FIG. 1 shows an example of a tactile sensor 22 according to an embodiment of the disclosure. In FIG. 1, the vertical direction is the thickness direction of the tactile sensor 22. For example, the tactile sensor 22 detects its deformation that is caused when its surface is pressed with a human finger. The tactile sensor 22 includes a body 24, a detection unit 26, and a control unit 28.

The body 24 is soft as a whole. The body 24 is placed on a substrate 30. The substrate 30 is harder than the body 24. The substrate 30 of the tactile sensor 22 is not particularly limited as long as the substrate 30 can support the body 24.

In the tactile sensor 22, the body 24 is comprised of a plurality of layers stacked in the thickness direction. The body 24 includes a surface layer 32 and a first deformation layer 34.

The surface layer 32 forms the upper surface of the body 24. The surface layer 32 is placed on the first deformation layer 34. As shown in FIG. 1, in the tactile sensor 22, the surface layer 32 is stacked on the first deformation layer 34.

The surface layer 32 is a sheet-like layer. In the tactile sensor 22, the surface layer 32 has a thickness of about 1 mm.

The surface layer 32 is comprised of a soft material and is elastically deformable. Examples of the soft material are rubber and elastomer. In the tactile sensor 22, the material of the surface layer 32 is not particularly limited as long as the surface layer 32 is elastically deformable. The surface layer 32 of the tactile sensor 22 is comprised of cross-linked rubber containing silicone rubber as a base material and having flexibility.

As used herein, the term “flexibility” means being so soft as to be easily deformable by, e.g., a pressing force of a human finger.

Although not shown in FIG. 1, in the tactile sensor 22, the surface layer 32 contains a magnetic material. Specifically, the surface layer 32 has the magnetic material dispersed therein. In the tactile sensor 22, the ratio of the mass of the magnetic material contained in the surface layer 32 to the total mass of the surface layer 32, namely the content of the magnetic material in the surface layer 32, is about 60 mass %. The content of the magnetic material in the surface layer 32 is determined as appropriate in view of the specifications of the tactile sensor 22.

The first deformation layer 34 is located under the surface layer 32 and is placed on a second deformation layer 36 described below. As shown in FIG. 1, in the tactile sensor 22, the first deformation layer 34 is stacked on the second deformation layer 36.

The first deformation layer 34 is a sheet-like layer. In the tactile sensor 22, the first deformation layer 34 has a thickness in the range of 3 mm to 4 mm.

The first deformation layer 34 is comprised of a soft material and is elastically deformable. Examples of the soft material are rubber and elastomer. In the tactile sensor 22, the material of the first deformation layer 34 is not particularly limited as long as the first deformation layer 34 is elastically deformable. The first deformation layer 34 of the tactile sensor 22 is comprised of cross-linked rubber containing silicone rubber as a base material and having flexibility. In the tactile sensor 22, the first deformation layer 34 does not contain any magnetic material. The first deformation layer 34 has about the same flexibility as, or higher flexibility than, the surface layer 32.

In the tactile sensor 22, the body 24 includes an element 38. The element 38 is an elastically deformable, long string-like element. The element 38 changes its inductance with its deformation.

The element 38 includes at least a coil 40. The coil 40 is formed by winding an enamel wire (wire) into a helix. In the tactile sensor 22, the coil 40 has a diameter in the range of 0.3 mm to 0.4 mm. The wire of the coil 40 has a diameter of 0.1 mm or less. The coil 40 is a very small coil.

In the tactile sensor 22, the element 38 is embedded in the first deformation layer 34. In other words, the element 38 is covered by the first deformation layer 34. The element 38 is placed in the first deformation layer 34 so as to extend in a direction parallel to the upper surface of the first deformation layer 34 on which the surface layer 32 is stacked. In FIG. 1, two arrows D indicate the distance from the surface layer 32 to the element 38. In the tactile sensor 22, the distance D is usually set in the range of 0.5 mm to 2 mm.

Although not shown in the figure, the tactile sensor 22 includes a plurality of the elements 38. In the tactile sensor 22, the elements 38 may be arranged either at regular intervals or in a grid pattern in the first deformation layer 34. The number of elements 38 that are embedded in the first deformation layer 34 and their arrangement are determined as appropriate in view of the specifications of the tactile sensor 22.

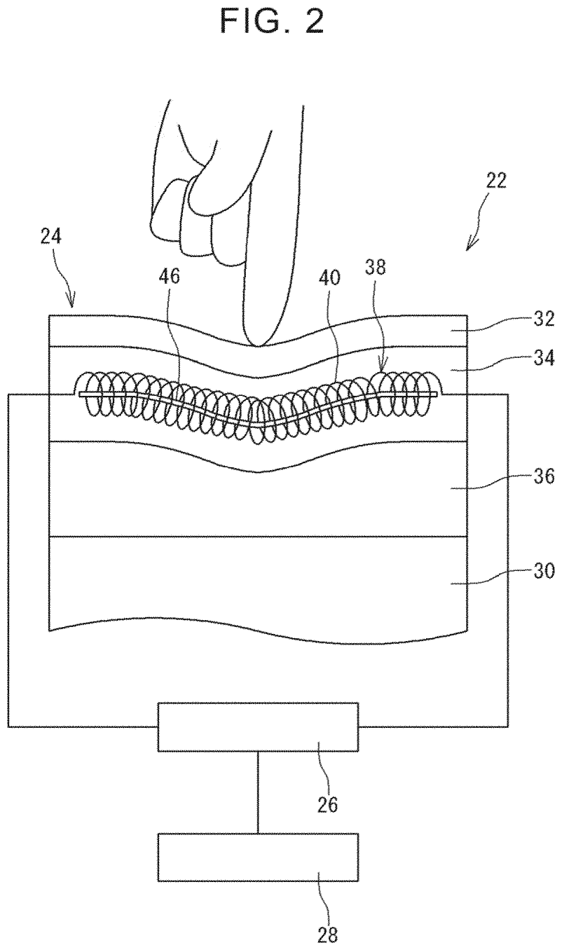

In the tactile sensor 22, as shown in FIG. 2, the body 24 is deformed when the surface of the body 24 is pressed with a human finger. In the tactile sensor 22, deformation of the body 24 is accompanied by deformation of the element 38. The inductance of the element 38 changes when the element 38 is deformed.

In the tactile sensor 22, the detection unit 26 is connected to the coil 40 of each element 38. The detection unit 26 detects the inductance of each element 38. The detection unit 26 can output the detected inductance as a signal in a time series manner. An example of the detection unit 26 is an LCR meter.

As described above, in the tactile sensor 22, the inductance of the element 38 changes when the surface of the body 24 is pressed and the element 38 is deformed. The detection unit 26 detects this change in inductance associated with the deformation.

In the tactile sensor 22, the control unit 28 is connected to the detection unit 26. The output signal of the detection unit 26 is input to the control unit 28. The control unit 28 processes this input signal and calculates, e.g., the amount of depression of the body 24. In the tactile sensor 22, the control unit 28 is comprised of, e.g., an arithmetic processing unit such as a computer, a part of the arithmetic processing unit, etc.

As described above, the tactile sensor 22 includes the body 24, the detection unit 26, and the control unit 28. In the disclosure, the tactile sensor 22 may be comprised only of the body 24. In this case, the tactile sensor 22 comprised only of the body 24 is connected to, e.g., an LCR meter serving as a detection unit equivalent to the detection unit 26 and an arithmetic processing unit serving as a control unit equivalent to the control unit 28.

In the tactile sensor 22, when the surface layer 32 is pressed and elastically deformed, the first deformation layer 34 is also elastically deformed. Since the element 38 is embedded in the first deformation layer 34, the element 38 is also deformed as shown in FIG. 2 when the surface layer 32 is deformed. In the tactile sensor 22, the inductance of the element 38 changes with deformation of the element 38 itself.

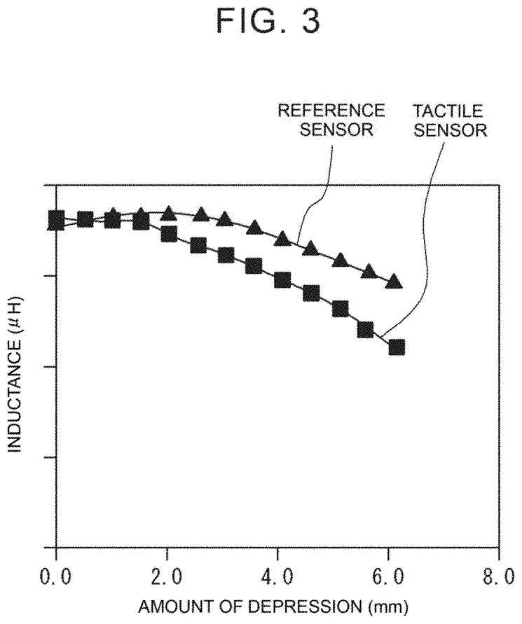

FIG. 3 is a graph showing the relationship between the amount of depression of the body 24 of the tactile sensor 22 caused by pressing the body 24 with a jig (not shown) and the measured value of the inductance corresponding to the amount of depression of the body 24. In the graph, the ordinate axis represents the inductance and the abscissa axis represents the amount of depression. FIG. 3 shows comparison between the measurement result of the tactile sensor 22 shown in FIG. 1 and the measurement result of a different tactile sensor having no surface layer 32 (hereinafter referred to as the reference sensor). Although not shown in the figure, the reference sensor has a configuration similar to that of the tactile sensor 22 except that the reference sensor does not have the surface layer 32.

As shown in FIG. 3, in both the tactile sensor 22 and the reference sensor, the inductance decreases with an increase in amount of depression. That is, the level of deformation is detected as a change in inductance. Especially, in the tactile sensor 22 having the surface layer 32 containing a magnetic material, the ratio of the change in inductance to the change in amount of depression, namely the rate of change in inductance, is higher than in the reference sensor having no surface layer 32. In the tactile sensor 22, the surface layer 32 containing a magnetic material improves the rate of change in inductance. The tactile sensor 22 thus has high sensitivity to deformation.

Since deformation of the element 38 itself is reflected on a change in inductance, the elastically deformable surface layer 32 or the elastically deformable first deformation layer 34 of the tactile sensor 22 can have a sufficient thickness. In other words, the surface layer 32 or the first deformation layer 34 of the tactile sensor 22 can have a sufficient thickness within such a range that does not inhibit deformation of the element 38 itself. The tactile sensor 22 thus has high sensitivity to deformation while having sufficient flexibility.

In the tactile sensor 22, the surface layer 32 contains a magnetic material and a part of the magnetic material is exposed on the upper surface of the surface layer 32. Sticking of the surface layer 32 is thus effectively reduced. The tactile sensor 22 is thus effectively prevented from sticking to a human finger or similar objects.

As shown in FIG. 1, in the tactile sensor 22, the body 24 can include the second deformation layer 36 under the first deformation layer 34. In the tactile sensor 22, the first deformation layer 34 is placed on the second deformation layer 36.

In the tactile sensor 22, the first deformation layer 34 is stacked on the second deformation layer 36, and the second deformation layer 36 is stacked on the substrate 30. The second deformation layer 36 is thus located between the first deformation layer 34 and the substrate 30.

The second deformation layer 36 is a sheet-like layer. In the tactile sensor 22, the second deformation layer 36 has a thickness of about 4 mm.

The second deformation layer 36 is comprised of a soft material and is elastically deformable. Examples of the soft material are rubber and elastomer. In the tactile sensor 22, the material of the second deformation layer 36 is not particularly limited as long as the second deformation layer 36 is elastically deformable. The second deformation layer 36 of the tactile sensor 22 is comprised of cross-linked rubber containing silicone rubber as a base material and having flexibility. In the tactile sensor 22, the second deformation layer 36 does not contain any magnetic material.

In the tactile sensor 22, the second deformation layer 36 is more flexible than the first deformation layer 34. Since the first deformation layer 34 is sufficiently deformable, a force pressing the surface layer 32 effectively acts on the element 38. Since deformation caused by the pressing force is sufficiently reflected on deformation of the element 38, the tactile sensor 22 has further improved sensitivity to deformation. The tactile sensor 22 thus has higher sensitivity to deformation while having more sufficient flexibility. In view of this, it is preferable that the tactile sensor 22 include the elastically deformable second deformation layer 36, the first deformation layer 34 be placed on the second deformation layer 36, and the second deformation layer 36 be more flexible than the first deformation layer 34.

As described above, in the tactile sensor 22, the surface layer 32 contains a magnetic material. In order to improve sensitivity to deformation, it is preferable that the magnetic material be soft magnetic metal powder. Examples of the metal powder are spherical atomized powder and flat atomized powder.

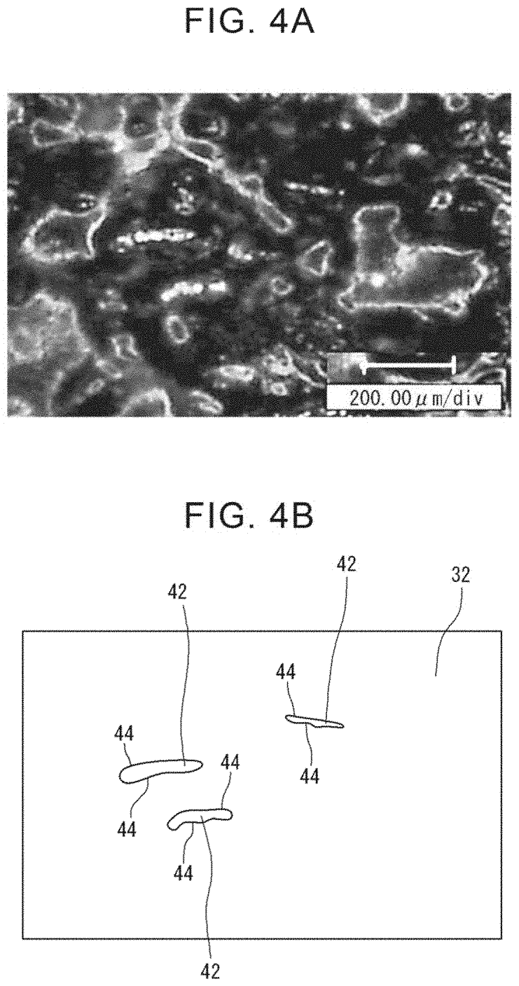

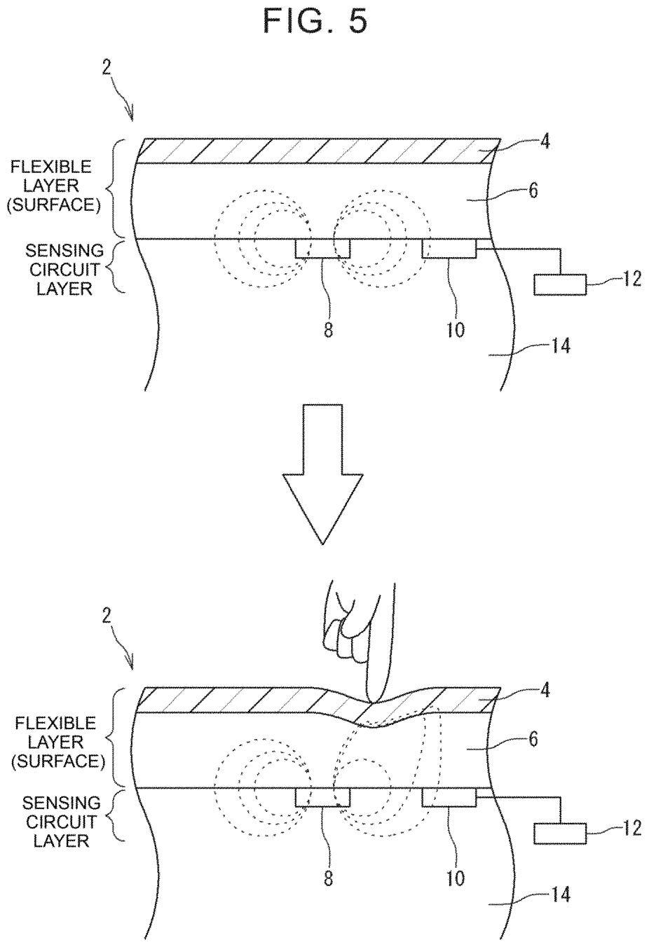

FIG. 4A shows an electron micrograph of a section of the surface layer 32. In FIG. 4A, the vertical direction is the thickness direction of the surface layer 32. Although not shown in the figure, the upper surface of the surface layer 32, namely the upper surface of the body 24, is located on the upper side in FIG. 4A, and the lower surface of the surface layer 32 is located on the lower side in FIG. 4A. In the tactile sensor 22, the lower surface of the surface layer 32 is placed on the upper surface of the first deformation layer 34.

FIGS. 4A and 4B show the dispersed state of a magnetic material 42 in the surface layer 32. In order to explain the dispersed state of the magnetic material 42, FIG. 4B shows a replica of the electron micrograph of FIG. 4A.

The magnetic material 42 in the surface layer 32 shown in FIG. 4B is flat atomized powder. As shown in FIG. 4B, in the section of the surface layer 32 taken along the thickness direction, the magnetic material 42, namely the flat atomized powder, is recognized as streaks extending in the lateral direction. That is, the flat atomized powder is dispersed in the surface layer 32 of the tactile sensor 22 so that surfaces 44 of the flat atomized powder face the upper or lower surface of the surface layer 32. In other words, the magnetic material 42 is dispersed in the surface layer 32 with all atomized powder particles in the same orientation. In the tactile sensor 22, the magnetic material 42 being dispersed in the surface layer 32 with all atomized powder particles in the same orientation means the magnetic material 42 being oriented. This orientation of the magnetic material 42 in the surface layer 32 can be obtained by forming the surface layer 32 by pressure forming.

As described above, in the tactile sensor 22, each of the elements 38 is placed in the first deformation layer 34 so as to extend in a direction parallel to the upper surface of the first deformation layer 34 on which the surface layer 32 is stacked. Accordingly, in the case where flat atomized powder is used as the magnetic material 42 of the tactile sensor 22, the magnetic material 42 dispersed in the surface layer 32 is oriented so as to extend in the direction in which the element 38 extends. That is, in the tactile sensor 22, orientation of the magnetic material 42 dispersed in the surface layer 32 is facilitated.

The use of flat atomized powder as the magnetic material 42 of the tactile sensor 22 facilitates orientation of the magnetic material 42 dispersed in the surface layer 32. This orientation of the magnetic material 42 improves sensitivity to deformation. The tactile sensor 22 thus has higher sensitivity to deformation while having more sufficient flexibility. In view of this, in the tactile sensor 22, it is preferable that the magnetic material 42 have a flat shape, and more specifically, the magnetic material 42 be flat atomized powder.

In the tactile sensor 22, the element 38 may include a core material 46 in addition to the coil 40. The core material 46 is placed along the coil 40. Specifically, as shown in FIG. 1, the core material 46 is inserted through the center of the coil 40.

In the tactile sensor 22, the core material 46 is comprised of an amorphous metal fiber. An example of the amorphous metal fiber is “Sency (registered trademark)” made by Aichi Steel Corporation.

Since amorphous metal fibers do not have crystal magnetic anisotropy, the use of an amorphous metal fiber as the core material 46 further increases a change in inductance associated with deformation of the element 38. The tactile sensor 22 thus has further improved sensitivity to deformation. The tactile sensor 22 therefore has higher sensitivity to deformation while having more sufficient flexibility. In view of this, in the tactile sensor 22, it is preferable that the element 38 include the core material 46 comprised of an amorphous metal fiber in addition to the coil 40 and the core material 46 be placed along the coil 40. In order to improve sensitivity to deformation, it is more preferable that the core material 46 be inserted through the center of the coil 40 in the case where the element 38 includes the coil 40 and the core material 46.

As can be seen from the above description, the disclosure provides the tactile sensor 22 having high sensitivity to deformation while having sufficient flexibility.

The embodiment disclosed herein is merely illustrative in all aspects and not restrictive. The technical scope of the disclosure is not limited to the above embodiment and includes all modifications that are made without departing from the scope of the claims.

The tactile sensor described above can be used in medical applications such as artificial hands. This tactile sensor is also applicable to automobile parts to be touched by humans, such as a steering wheel, and can be used as a communication tool between a driver and an automobile.

What is claimed is:

1. A tactile sensor, comprising:
an element that changes an inductance of the element with deformation of the element and that includes a coil;
a first deformation layer that has the element embedded in the first deformation layer and is elastically deformable together with the element; and
an elastically deformable surface layer that is placed on the first deformation layer and contains a magnetic material.

2. The tactile sensor according to claim 1, wherein the magnetic material has a flat shape.

3. The tactile sensor according to claim 2, wherein:
the element includes a core material comprised of an amorphous metal fiber; and
the core material is placed along the coil.

4. The tactile sensor according to claim 3, further comprising an elastically deformable second deformation layer, wherein:
the first deformation layer is stacked on the second deformation layer; and
the second deformation layer is more flexible than the first deformation layer.

5. The tactile sensor according to claim 1, wherein:
the element includes a core material comprised of an amorphous metal fiber; and
the core material is placed along the coil.

6. The tactile sensor according to claim 5, further comprising an elastically deformable second deformation layer, wherein:
the first deformation layer is stacked on the second deformation layer; and
the second deformation layer is more flexible than the first deformation layer.

7. The tactile sensor according to claim 1, further comprising an elastically deformable second deformation layer, wherein:
the first deformation layer is stacked on the second deformation layer; and
the second deformation layer is more flexible than the first deformation layer.
